(19) United States
(12) Patent Application Publication
(10) Pub. No.: US 2007/0146245 A1
(43) Pub. Date: Jun. 28, 2007

(54) DISPLAY APPARATUS

(75) Inventors: Tatsuhito GODEN, Kawasaki-shi (JP); Somei Kawasaki, Saitama-shi (JP); Masami Iseki, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/559,559

(22) Filed: Nov. 14, 2006

(30) Foreign Application Priority Data
Nov. 16, 2005 (JP) 331601/2005(PAT.)

(51) Int. Cl. G09G 3/30

(52) U.S. Cl. 345/76

(57) ABSTRACT

A display apparatus includes, on a substrate, an area in which a plurality of constituents each including a light-emitting device and a device control circuit for controlling current passing through the light-emitting device is disposed, a common interconnecting line disposed to surround a periphery of the area, a terminal portion for permitting electrical connection to an external circuit, and a wiring lead-out portion for electrically connecting the common interconnecting line to the terminal portion. The light-emitting device is disposed, on the substrate, between a lower first electrode and an upper second electrode. The first electrode is electrically connected to the device control circuit, and the second electrode is electrically connected to the common interconnecting line through a contact hole. The common interconnecting line disposed along a side of the area most distant from the wiring lead-out portion has a narrower width than a width of the common interconnecting line disposed along a side of the area closer to the wiring lead-out portion.

### FIELD OF THE INVENTION AND RELATED ART

The present invention relates to a current drive-type display apparatus having an area in which a plurality of constituents each including a current drive-type light-emitting device and a device control circuit for controlling current passing through the light-emitting device is disposed on a substrate, and relates to a camera including the display apparatus. The present invention is suitably used in a display apparatus using an electroluminescence (EL) device which produces luminescence by injecting current therein.

A display panel applied to a lightweight and compact apparatus requires a small substrate size and a sufficiently large display area. For this reason, it is desirable that a peripheral area of the display area, i.e., a frame area is as small as possible. In the frame area, a peripheral circuit or a signal processing circuit, an interconnecting line for supplying electric power, and in the case of using a sealing substrate, an adhesion area for effecting adhesion of the sealing substrate, are disposed. In order to provide a narrow frame, it is necessary to reduce these members in size.

In an active matrix-type EL display apparatus containing therein the peripheral circuit or the signal processing circuit, in not only the display area but also the peripheral circuit or the signal processing circuit, an analog switch or a thin film transistor (TFT) as a transistor such as an inverter or the like has been used.

The TFT used in the peripheral circuit or the signal processing circuit is ordinarily a polysilicon TFT. The polysilicon TFT is produced through a low-temperature crystallization technology used for producing a high performance and inexpensive TFT for a peripheral drive circuit. A currently practical and typical crystallization technology is a low-temperature crystallization method using excimer laser, and it is possible to form a good-quality silicon crystal thin film on a low melting point glass material. Japanese Laid-Open Patent Application (JP-A) Hei 09-082641 discloses a method of effecting low-temperature crystallization of silicon in an atmosphere containing catalyst element.

In order to reduce a production cost of the display panel, a large-sized glass substrate having a diagonal dimension of 1 m or more is subjected to a multiple method in which the glass substrate is divided into a plurality of unit substrates. However, the glass substrate is large, so that the glass substrate itself has a large shrinkage. As a result, alignment accuracy is approximately 1 μm, thus being not high. Further, it is difficult to form respective metal layer patterns at a processing accuracy of 2 μm or less by a currently available large-size pattern processing apparatus (etching apparatus etc.). For this reason, it is required that the peripheral circuit or the signal processing circuit is formed according to a relatively moderate design rule.

As described above, it is not easy to provide the peripheral circuit or signal processing circuit with high resolution from the viewpoints of production such as the alignment accuracy and the processing accuracy.

In an organic EL panel, when moisture permeates an organic EL device, an associated pixel results in a defective dot. In addition, adjacent pixels of the moisture-permeated pixel are successively adversely affected by the moisture-permeated pixel to increase a dark spot as a non-luminous area. Finally, the entire display panel cannot effect display. For this reason, it is required that external (ambient) air and moisture is blocked from entering the EL device.

For this purpose, from the viewpoints of prevention of moisture permeation and physical protection, a sealing substrate onto which a drying agent is applied at its inner surface is adhesively fixed to cover a display area in which the organic EL device is disposed. The adhesion fixation is effected by an adhesive, called a sealing agent, of an epoxy-type or acrylic-type. JP-A Hei 01-313892 has proposed an organic EL device such that the adhesive is applied onto an adhesion area surrounding an outer periphery of a display area and a sealing substrate is adhesively fixed by the adhesive in the adhesion area.

As a method of decreasing a moisture permeation amount while enhancing a sealing ability in such a structure, such a constitution that ingress of ambient air into the EL device is prevented by increasing a sealing width is also adopted. In this case, however, it is necessary to ensure a certain margin from a substrate edge to an outer periphery of the sealing adhesive from the viewpoint of reliability. Further, the display area is located inside the sealing adhesive, so that when a width of the sealing adhesive is increased to enhance the sealing ability while keeping an outside shape of the panel, a resultant frame area is naturally increased, thus decreasing an area of the display area. On the other hand, when the adhesion area of the sealing substrate is decreased, the sealing ability is lowered. As a result, there is a possibility that the defective pixel is increased, thus causing a deterioration in display state.

U.S. Pat. No. 6,690,110 has disclosed, as a method of electrically connecting a cathode of an organic EL device to an external terminal, a method wherein a rectangular transparent common electrode constituting the cathode is electrically connected to a low-resistivity metal interconnecting line through a contact hole in the neighborhood of a side of the common electrode, and the metal interconnecting line is electrically connected to the external terminal.

When the contact hole is provided around the display area so as to surround the display area, an insulating layer formed in the display area is interrupted by the contact hole. In many cases, the insulating layer is formed of an organic resin material, so that moisture externally can enter the display area through the insulating layer. However, in the method described above, the resinous layer in the display area and that outside the display area are interrupted by the contact hole, so that it is possible to prevent the moisture permeation (ingress). It is naturally required that a contact hole having a certain width is provided in order to block the moisture permeation. This is also a factor to the increase in frame area.

Further, in order to supply current to not only the cathode but also an anode, power interconnecting lines are required. These power interconnecting lines are disposed in a peripheral area of the display area and required to have a large width in order to lower en electric resistance. Further, in order not to change a voltage value depending on a distance from the power interconnecting lines, the power interconnecting lines are frequently disposed at all the four sides along the display area. As a result, at either side, a wide frame area is required, so that it is more difficult to reduce the frame area of the display panel.

### SUMMARY OF THE INVENTION

An object of the present invention is to provide a display apparatus capable of reducing a frame size by efficiently arranging interconnecting lines, circuits, etc.

According to the present invention, there is provided a display apparatus comprising:

a plurality of light-emitting devices and a plurality of device control circuits for controlling current passing through the light-emitting devices, the light-emitting devices and the device control circuits being arranged on a substrate in a row direction and column direction to form a display area, wherein each of the light-emitting devices is disposed between a lower first electrode and an upper second electrode on the substrate, the first electrode being provided for each light-emitting device and electrically connected to an associated device control circuit for the light-emitting device, and the second electrode being an electrode common to all the light-emitting devices and extended to a periphery of the display area;

a common interconnecting line disposed along a side of a display area, the common interconnecting line having an area overlapping with the extended second electrode through an insulating layer which is interposed therebetween and is provided with a contact hole through which the common interconnecting line is electrically connected to the extended second electrode; and

a lead-out interconnecting line branching off from the common interconnecting line at a portion of the common interconnecting line and leading the common interconnecting line through a connection terminal to an external circuit, wherein the common interconnecting line, disposed along a side of the display area most distant from a lead-out portion at which the lead-out interconnecting line branches off from the interconnecting line, has a width narrower than a width of the common interconnecting line disposed along other sides of the display area.

In the display apparatus of the present invention, as a light-emitting device, it is possible to use an EL device represented by, e.g., an organic EL device. By using a plurality of organic EL devices (light-emitting devices), it is possible to constitute the display apparatus. Each organic EL device emits light at a luminance (brightness) depending on current passing through the device, thus being called a current drive-type light-emitting device. An inorganic EL light-emitting device and a semiconductor laser device are also the current drive-type light-emitting device, so that the present invention is also applicable to these devices.

According to the display apparatus of the present invention, a layout area is capable of being reduced by decreasing a width of an area, in which an amount of current in a common interconnecting line, disposed to surround an area in which a plurality of constituents each including a current drive-type light-emitting device and a device control circuit. As a result, it is possible to reduce a frame size of the substrate. Further, by the wiring design in view of current path, a width of the common interconnecting line on a side where a drive circuit for driving the device control circuit is disposed is decreased, so that it is possible to suppress an increase in frame size resulting from an increase in circuit area. Thus, it is possible to provide a display apparatus capable of alleviating the increase in frame size in order to realize an apparatus of light weight and compact.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic layout view showing a display apparatus according to Embodiment 1 of the present invention.

FIG. 2 is a circuit diagram showing a pixel circuit of a current drive-type including an EL device.

FIG. 3 is a perspective view showing a three-dimensional arrangement of the EL device and a cathode.

FIGS. 4(a) and 4(b) are partial enlarged views each showing a common interconnecting line.

FIGS. 5 to 8 are schematic layout views showing display apparatuses according to Embodiments 2 to 5, respectively, of the present invention.

FIG. 9 is a block diagram of an embodiment of a digital still camera.

### DETAILED DESCRIPTION OF THE PREFERRED EMBODIMENTS

As described above, the display apparatus according to the present invention includes the plurality of current drive-type light-emitting devices capable of producing luminescence at a luminance depending on current passing through the light-emitting devices.

In the display apparatus of the present invention, a current drive-type light-emitting (luminescence) device may be a device which is disposed between a lower first electrode and an upper second electrode and emits light through either one of the upper and lower electrodes.

It is possible to constitute a display apparatus by one-dimensionally or two-dimensionally arrange constituents including the current drive-type light-emitting device and a switching element in combination.

The display apparatus may be a linear display apparatus for displaying image information, an active matrix-type display apparatus, etc. The linear display apparatus can be used as a scanner and can constitute an image recording apparatus, such as an optical printer or a copying machine, by being used in combination with a photosensitive member. The active matrix-type display apparatus can be used as a viewer for use in a flat panel television, digital camera, digital video camera, etc., or a display portion of a mobile phone, etc.

A device control circuit is a circuit for controlling current passed through the above described current drive-type light-emitting device and a simplest constitution thereof is a transistor. In embodiments described later, the device control circuit has such a circuit constitution that a value of current to be supplied to a control electrode (gate etc.) for a transistor for supplying current to the light-emitting device is programmed in advance. The device control circuit includes the transistor for supplying current to the light-emitting device and a transistor for writing the current value in the control electrode (gate etc.) for the former transistor.

The current passing through the light-emitting device is carried to the common interconnecting line through the contact hole and further carried from the wiring lead-out portion toward the terminal portion. Further, the current to be passed through the light-emitting device may sometimes flow into the light-emitting device via the common interconnecting line and the contact hole.

With respect to the plurality of constituents each including a light-emitting device and a device control circuit, an amount of current passing through a common interconnecting line located on a side opposite to a side where the wiring lead-out portion is located is smaller than that of a common interconnecting line located at the wiring lead-out portion. For this reason, by decreasing a width of the common interconnecting line (or widths of the common interconnecting line and contact hole), it is possible to reduce a layout area. Along the side where the layout area is reduced, drive circuits such as a data line drive circuit and a scanning line are disposed. In this regard, the data line drive circuit having a large layout area may preferably be disposed.

In a preferred embodiment of the present invention, an active matrix-type display apparatus using an EL device represented by an organic EL device is employed. Hereinbelow, the embodiment of the active matrix-type display apparatus according to the present invention will be described.

### Embodiment 1

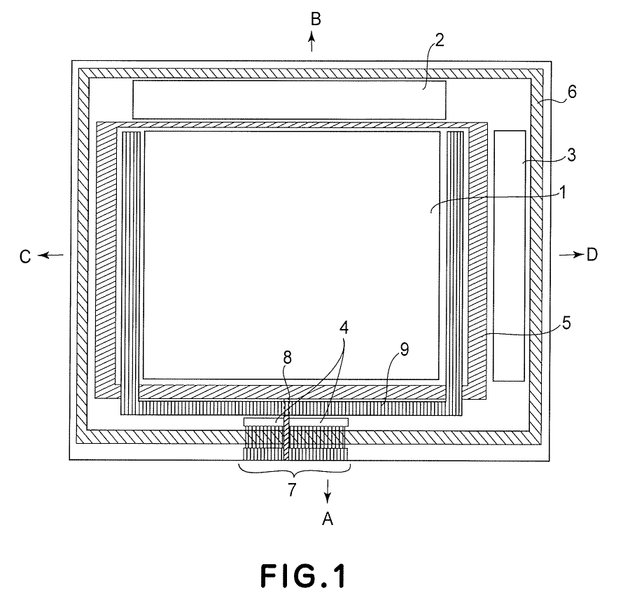

FIG. 1 is a schematic layout view of a display apparatus according to Embodiment 1 of the present invention.

The display apparatus shown in FIG. 1 includes a display area 1 in which pixels (constituents) each comprising an EL device such as an organic EL device or the like and a pixel circuit (device control circuit) including a thin film transistor (TFT) are arranged in a matrix.

The display apparatus further includes a data line drive circuit 2 for outputting a data signal to data lines electrically connected to associated pixel columns, respectively, a scanning line drive circuit 3 for outputting a scanning signal to scanning liens electrically connected to associated pixel rows, respectively, a terminal portion 7 for inputting an image signal or a control signal and supplying electric power, an input circuit 4 for converting the inputted control signal into an operation voltage level in a display panel, an adhesive area 6 for effecting adhesion of a sealing substrate, and a common interconnecting line 5 electrically connected to an EL device of each pixel.

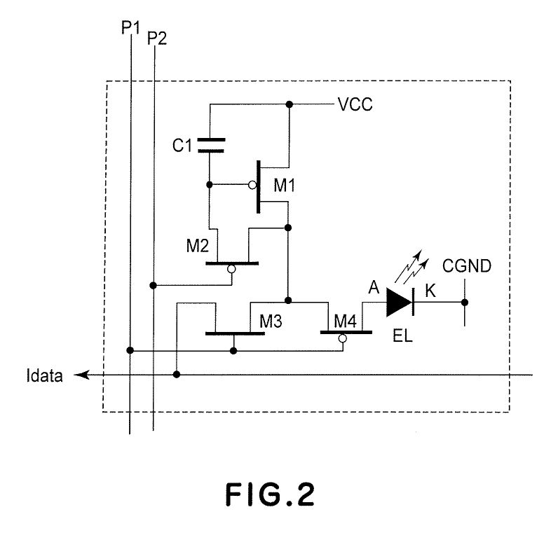

The common interconnecting line 5 is disposed to surround a periphery of the display area 1 and is connected to a part of the terminal portion 7 via an interconnecting line extended from a wiring lead-out portion 8. An output signal from the input circuit 4 is transmitted to the data line drive circuit 2 and the scanning line drive circuit 3 but interconnecting lines therefor are not shown in FIG. 1. A power supply line 9 is used to supply electric power (voltage or current) to each pixel circuit. The power supply line 9 and each pixel circuit are connected to each other in the following manner. First, a source of a transistor M1 (shown in FIG. 2) of each pixel circuit along pixel rows is connected to a power line provided for each pixel row. Then, the power line is connected to the power supply line 9 disposed between the display area 1 and the common interconnecting line 5 to ensure the connection between the power supply line 9 and each pixel circuit. In this embodiment, the power line and the power supply line 9 are connected in a ladder-like shape, and the power supply line is disposed in a U-character shape.

FIG. 2 shows a pixel circuit of a current setting-type including an EL device.

Referring to FIG. 2, scanning signals are inputted into scanning lines P1 and P2, and a current data Idata is inputted into a data line. An anode (A) of an EL device is connected to a drain of a transistor M4 and a cathode (K) of the EL device is grounded to grounded potential CGND.

The current data Idata is inputted into a source of a transistor M3, and a gate of the transistor M3 and a gate of the transistor M4 are connected to the scanning line P1. A source of the transistor M4 is connected to drains of the transistor M3, a transistor M2, and a transistor M1. A gate of the transistor M1 is connected to one terminal of a capacitor C1 connected to a power supply line (voltage VCC) at the other terminal and is also connected to a source of the transistor M2. A gate of the transistor M2 is connected to the scanning line P2, and a source of the transistor M1 is connected to the power supply line (voltage VCC).

The transistors M1 and M4 are transistors for supplying current to the EL device, which is grounded to GND through a common voltage line. The transistors M2 and M3 are transistors for writing a value of current, to be carried to the EL device, to the gate of the transistor M1. In a voltage programming period for writing the current value to the gate of the transistor M1, the transistors M2 and M3 as a switch element are turned on, and the transistor M4 as a switch element is turned off. In a subsequent luminescent period for supplying current to the EL device, the transistors M2 and M3 are turned off, and the transistor M4 is turned on.

Incidentally, in this embodiment, the pixel circuit shown in FIG. 2 is used as an example. However, the pixel circuit usable in the present invention is not limited thereto but may also be applicable to other pixel circuits of the current setting type or of a voltage setting-type.

In this embodiment, a light-emitting surface of the light is on the cathode side of the EL device, and the cathode is formed of a transparent electroconductive material such as ITO (indium oxide and tin oxide) or IZO (indium oxide and zinc oxide) and is connected to the common interconnecting line 5 shown in FIG. 1, so that drive current during luminescence of the EL device flows into the common interconnecting line 5.

Next, connection between the common interconnecting line 5 and the EL device of each pixel will be described in detail.

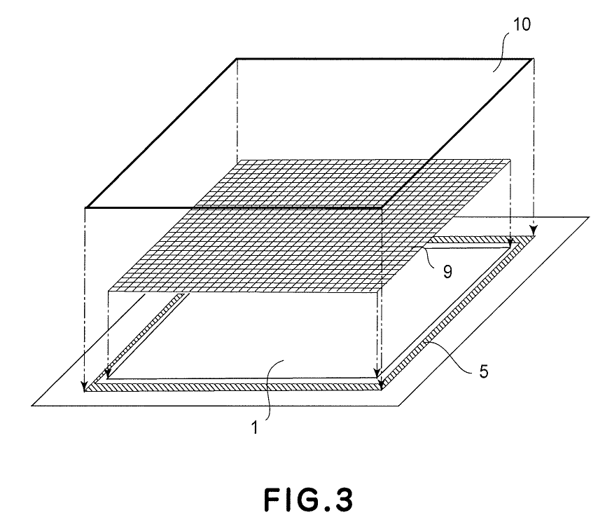

In FIG. 2, the EL device and the grounding line to the ground potential CGND are indicated inclusively in the pixel circuit but with reference to FIG. 3, a three-dimensional arrangement including these members will be described. From FIG. 3, the data line drive circuit 2, the scanning line drive circuit 3, the input circuit 4, the adhesion area 6, the terminal portion 7, and the wiring lead-out portion 8 are omitted for simplicity.

In the display area 1, the pixel circuit, e.g., including, e.g., the transistors M1 to M4 and the capacitor C1 shown in FIG. 2 is formed, and the anode (A) of the EL device connected to the transistor (TFT) M4 is also formed. On the anode, an EL device 9 is vapor-deposited in accordance with a pixel arrangement to join the anode and the EL device 9 together. On the EL device 9, a cathode 10 is formed of a transparent electroconductive material. The cathode 10 is also formed on a common electrode (common interconnecting line) 5 disposed at a periphery of a display area 1. In this case, an insulating layer (not shown) on the common electrode 5 is provided with a contact hole (not shown) so as to expose a surface of the common electrode 5. As a result, the cathode 10 of the EL device 10 and the common electrode 5 are electrically connected to each other to be grounded.

As described above, the cathode 10 is extended in a peripheral area of the display area and overlaps with the common interconnecting line (common electrode) 5 via the insulating layer in the peripheral area. In this area, the cathode 10 is connected to the common interconnecting line 5 by providing the contact hole in the insulating layer.

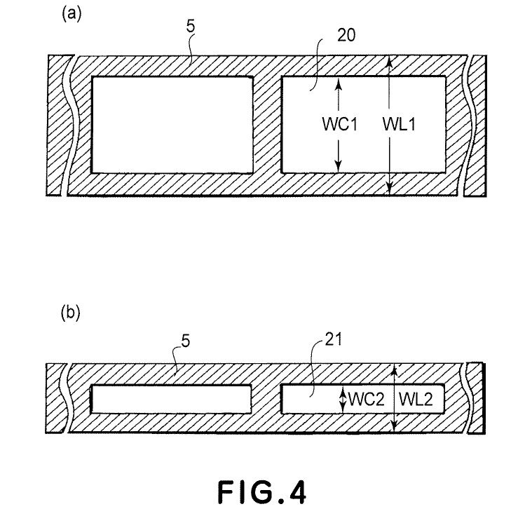

A connection portion between the common interconnecting line 5 and the cathode 10 will be described with reference to FIGS. 4(a) and 4(b).

FIG. 4(a) is a partially enlarged view of the common interconnecting line 5 on a side A shown in FIG. 1. On the common interconnecting line 5, a contact hole 20 is provided, and thereon, the cathode 10 is formed. A switch WL1 of the common interconnecting line 5 is larger than a width WC1 of the contact hole 20 by a process margin. FIG. 4(b) is a partially enlarged view of the common interconnecting line 5 on a side B shown in FIG. 1. The common interconnecting line 5 on the side B is located opposite to the wiring lead-out portion 8 via the display area 1 as shown in FIG. 1. A constitution f FIG. 4(b) is identical to that of FIG. 4(a) except for a width WC2 of a contact hole 21 and a width WL2 of the common interconnecting line 5. More specifically, the widths WC1 and WC2 of the contact holes 20 and 21 and the widths WL1 and WL2 of the common interconnecting lines 5 satisfy the following relationships: WC1>WC2 and WL1>WL2, so that the contact hole width and the common interconnecting line width on the side B are narrower than those on the side A. Incidentally, the contact hole may also be provided in a rectangular shape along four sides of the transparent electrode.

Here, the reason why the contact hole width and the common interconnecting line width on the side B can be reduced will be described.

The current passing through the EL device carried to the terminal portion 7 through the cathode 10 formed in the display area 1, the common interconnecting line 5, and the wiring lead-out portion 8. When the flowing direction of the current from the cathode 10 toward the wiring lead-out portion 8 and the location of the common interconnecting line 5 on the side B opposite, via the display area 1, from a side where the wiring lead-out portion 8 is located are taken into consideration, an amount of current flowing in a direction of the side B is smaller than those of current flowing in directions of sides A, C and D. In other words, an amount of current at the contact portion between the cathode 10 and the common interconnecting line 5 on the side B is decreased, so that the contact hole width on the side B can be reduced. As a result, the common interconnecting line width can also be reduced. As described above, when the width of the common interconnecting line 5 located along the furthermost side of the display area 1 when viewed from the lead-out portion where the lead-out interconnecting line branches from the common electrode can be made narrower than those disposed along other sides of the display area 1.

In FIGS. 4(a) and 4(b), both of the common interconnecting line width and the contact hole width are smaller on the side B than on the side A but only the common interconnecting line width on the side B may also be smaller than that on the side A. Generally, when the common interconnecting line width is decreased, the contact hole width is also decreased. Accordingly, when the common interconnecting line width on the side B is made smaller than the common interconnecting line width on the side A, the contact hole width on the side B is also smaller than the contact hole width on the side A. However, for example, in the case where an increase in electric resistance at the contact hole portion is of no problem or the case where a difference in width between the common interconnecting lines is small, the contact hole width on the side A may also be equal to that on the side B. Further, it is also possible to form only the common interconnecting line without providing the contact hole on the side B.

In FIG. 1, the data line drive circuit 2 is disposed on the side B, thus generally leading to an increase in frame area. However, in this embodiment, the common interconnecting line width on the side B can be reduced as described above, so that the increase in frame area (size) can also be suppressed.

The power line to which the source of the transistor M1 (shown in FIG. 2) of each pixel circuit is electrically connected may also be disposed in the column direction. In this case, the power supply line 9 is also formed along the side, of the display area 1, close to the side B in a rectangular shape, not the U-character shape. Further, the power source line not shown in FIG. 1 vertically extends in the display area 1. Also in this case, a distribution of current passing through the cathode is not changed, so that it is possible to reduce the width of the common interconnecting line 5 on the side B which is the furthermost side from the lead-out portion 8 as shown in FIG. 1.

As described above, in this embodiment, the common interconnecting line 5 has a narrow width of the side most distant from the lead-out portion 8 even when the power line in the display area 1 extends in either of the row direction and the column direction.

### Embodiment 2

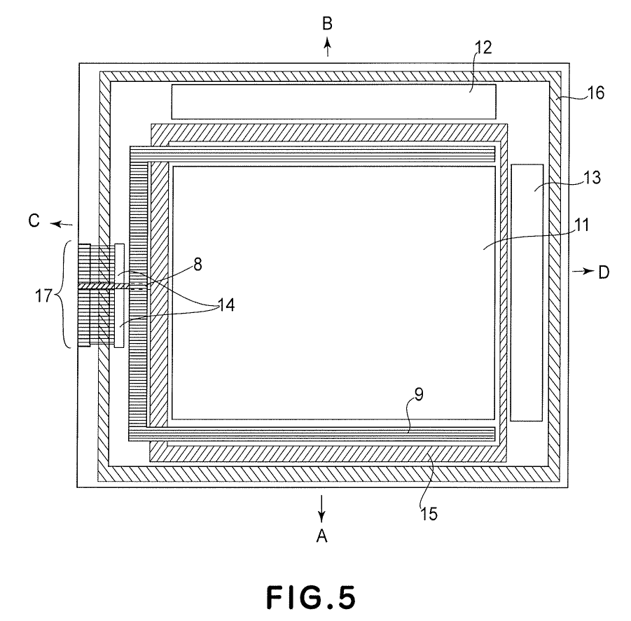

FIG. 5 is a schematic layout view of a display apparatus according to Embodiment 2 of the present invention.

In this embodiment, a side of a display area 11 most distant from the lead-out portion 8 is parallel to a signal line. Between the side and an edge of the substrate close to the side, a scanning line drive circuit is disposed.

The display apparatus shown in FIG. 5 includes a display area 11 in which pixels (constituents) each comprising an EL device and a pixel circuit (device control circuit) including a thin film transistor (TFT) are arranged in a matrix. A constitution of the pixel is identical to that shown in FIG. 2. Similarly, those of pixels in Embodiments described later are also identical to that shown in FIG. 2.

The display apparatus further includes a data line drive circuit 12 for outputting a data signal to data lines electrically connected to associated pixel columns, respectively, a scanning line drive circuit 13 for outputting a scanning signal to scanning liens electrically connected to associated pixel rows, respectively, a terminal portion 17 for inputting an image signal or a control signal and supplying electric power, an input circuit 14 for converting the inputted control signal into an operation voltage level in a display panel, an adhesive area 16 for effecting adhesion of a sealing substrate, and a common interconnecting line 15 electrically connected to an EL device of each pixel.

The common interconnecting line 15 is disposed to surround a periphery of the display area 11 and is connected to a part of the terminal portion 17 via an interconnecting line extended from a wiring lead-out portion 8. An output signal from the input circuit 14 is transmitted to the data line drive circuit 12 and the scanning line drive circuit 13 but interconnecting lines therefor are not shown in FIG. 5.

The constitution of FIG. 5 is different from that of FIG. 1 in that the terminal portion 17 and the wiring lead-out portion 8 are disposed on a side C shown in FIG. 5. In this case, an amount of current passing through the common interconnecting line 15 on a side D opposite, via the display area 11, from the side C is decreased. For this reason, an amount of current to be supplied to the common interconnecting line 15 on the side D may be small, so that a width of the common interconnecting line 15 is capable of being reduced.

Further, in FIG. 5, the scanning line drive circuit 13 is disposed on the side D, thus generally leading to an increase in frame area. However, in this embodiment, the common interconnecting line width on the side D can be reduced as described above, so that the increase in frame area (size) can also be suppressed.

### Embodiment 3

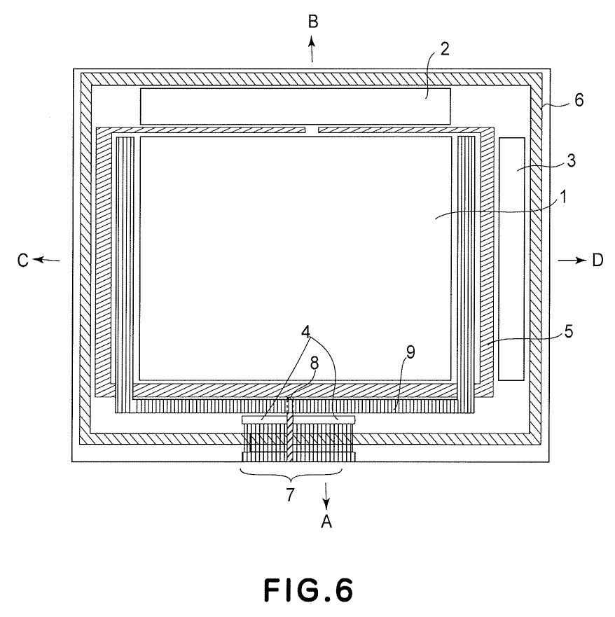

FIG. 6 is a schematic layout view of a display apparatus according to Embodiment 3 of the present invention.

A difference of this embodiment shown in FIG. 6 from Embodiment 1 shown in FIG. 1 is that a common interconnecting line 5 on a side B located opposite, via the display area 1, from the wiring lead-out portion 8 is interrupted, thus being not a continuous rectangular shape.

As in this case, even when the common interconnecting line 5 on the side B is partially cut off and fails to establish a continuous connection state, an amount of current flowing toward the side B is smaller than those of current flowing toward the sides A, C and D. For this reason, the influence of the cutting-off of the common interconnecting line 5 is small.

### Embodiment 4

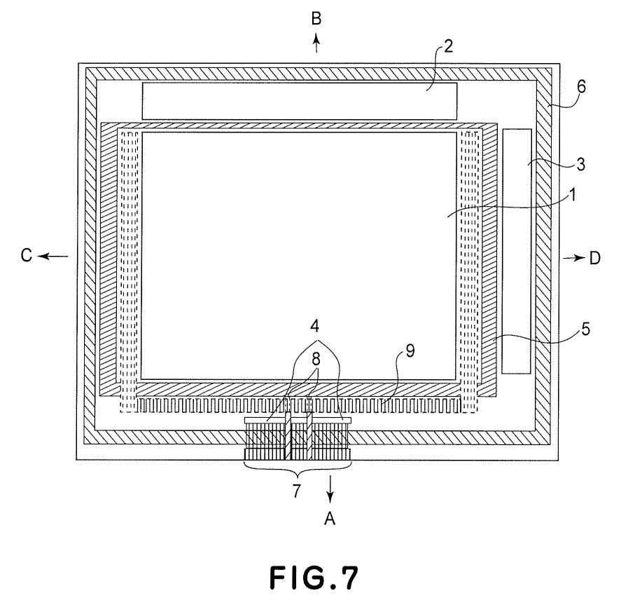

FIG. 7 is a schematic layout view of a display apparatus according to Embodiment 4 of the present invention.

In this embodiment, a plurality of lead-out portions is provided on a side close to a side of the display area.

A difference of this embodiment shown in FIG. 7 from Embodiment 1 shown in FIG. 1 is that a wiring lead-out portion 8 connected to the common interconnecting line 5 is disposed at two portions (this may also be three portions or more) on the side A shown in FIG. 7. Thus, by increase the number of the wiring lead-out portions 8 from one to two (or three or more), it is possible to decrease a density of current passing through the wiring lead-out portions.

### Embodiment 5

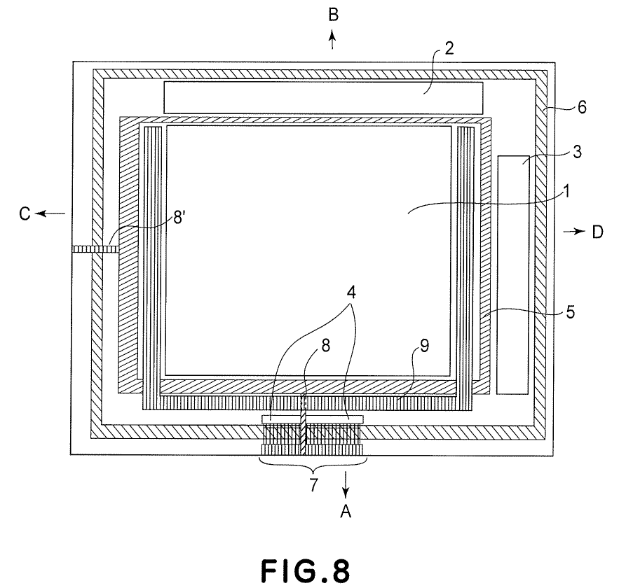

FIG. 8 is a schematic layout view of a display apparatus according to Embodiment 5 of the present invention.

In this embodiment, a lead-out portion is disposed on two sides of the display area, and widths of the common interconnecting line on these two sides of the display area are larger than those on the remaining two sides of the display area.

A difference of this embodiment shown in FIG. 8 from Embodiment 1 shown in FIG. 1 is that wiring lead-out portions 8 and 8′ are disposed on sides A and C and that a common interconnecting line width and a contact hole width are smaller on sides B and D than on the sides A and C.

Also in this embodiment, similarly as in Embodiment 4, by providing the wiring lead-out portion at two portions (or three or more portions), it is possible to decrease a density of current passing through the wiring lead-out portions 8 and 8′. Further, the common interconnecting line width and the contact hole width on the sides B and D are made smaller than those on the sides A and C as shown in FIG. 8, whereby it is possible to suppress an increase in frame size on the sides B and D.

In the above described embodiments 1-5, the constitution of the display apparatus of the present invention is not limited to those shown in the schematic layout views of FIGS. 1, and 5 to 8 but may also be any connection so long as the common interconnecting line width (or the common interconnecting line width and the contact hole width) on the side(s) opposite, via the display area, from the wiring lead-out portion(s) is decreased, and the width of the common interconnecting line decreased in amount of current depending on positions of wiring, the wiring lead-out portion, and the terminal portion is decreased.

Further, in the embodiments described above, current is passed through the EL device via the transistor constituting the pixel circuit for effecting current control and carried through the common voltage line. However, it is also possible to pass the current from the common voltage line to the EL device and carried to the power supply line through the transistor constituting the pixel circuit for effecting current control. For example, in the pixel circuit shown in FIG. 2, the transistor M1 is a PMOS transistor. However, it is also possible to employ such a constitution that an NMOS transistor is used as the transistor M1, a cathode-side portion of the EL device is connected to the transistor M4, an anode-side portion is connected to the common voltage line having a potential VCC, and the transistor M21 is connected to the power supply line which has been grounded.

Further, in the display apparatus of the present invention, the EL device is used but the present invention is not limited thereto. The above described display apparatuses in the respective Embodiments are a top emission-type organic EL display apparatus but the present invention is also applicable to an organic EL display apparatus of a bottom emission-type wherein light is emitted from a transparent substrate side where a pixel circuit is formed. In this case, a transparent electrode is used as the pixel electrode constituting a first electrode (lower layer) formed on a substrate. A second electrode (upper layer) may also be a transparent electrode. However, in the case of using reflected light, an electrode formed of metal material such as aluminum is used.

### Embodiment 6

The above described display apparatuses of the respective Embodiments are capable of constituting an information display apparatus which is an apparatus capable of realizing a mobile phone, a mobile computer, a still camera, a video camera, and a multifunction apparatus of these apparatuses. The information display apparatus includes an information input portion. For example, in the case of the mobile phone, the information input portion is constituted by containing an antenna. In the case of a PDA or the mobile computer, the input portion includes an interface portion for a network. In the case of the still camera or the video (movie) camera, the information input portion includes a sensor portion such as CCD or CMOS.

As a suitable embodiment, a digital camera using the display apparatus described above in any one of Embodiments 1-5 is used in electronic equipment will be described.

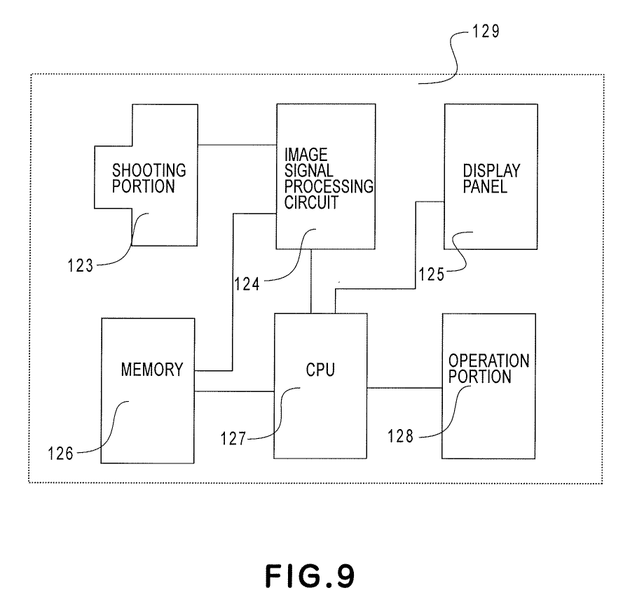

FIG. 9 is a block diagram of an example thereof of a digital still camera. Referring to FIG. 9, an entire system 129 includes an image shooting portion 123 for shooting a subject, an image signal processing circuit 124, a display panel 125, a memory 126, a CPU 127, and an operation portion 128. An image which is shot by the shooting portion 123 or stored in the memory 126 is signal-processed by the image signal processing circuit 124, and is viewable by the display panel 125. The CPU 127 controls the shooting portion 123, the memory 126, the image signal processing circuit 124, and the like based on an input from the operation portion, thus effecting shooting, recording, reproduction, or display depending on situation.

As described hereinabove, according to the current drive-type apparatus of the present invention, it is possible to employ the EL device (constituting a current drive-type light-emitting device) represented by, e.g., an organic EL device, so that a display apparatus can be constituted by the current drive-type apparatus.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 331601/2005 filed Nov. 16, 2005, which is hereby incorporated by reference.

What is claimed is:

1. A display apparatus comprising:
a plurality of light-emitting devices and a plurality of device control circuits for controlling current passing through said light-emitting devices, said light-emitting devices and said device control circuits being arranged on a substrate in a row direction and column direction to form a display area, wherein each of said light-emitting devices is disposed between a lower first electrode and an upper second electrode on the substrate, said first electrode being provided for each light-emitting device and electrically connected to an associated device control circuit for the light-emitting device, and the second electrode being an electrode common to all the light-emitting devices and extended to a periphery of the display area;
a common interconnecting line disposed along a side of a display area, said common interconnecting line having an area overlapping with the extended second electrode through an insulating layer which is interposed therebetween and is provided with a contact hole through which said common interconnecting line is electrically connected to the extended second electrode; and
a lead-out interconnecting line branching off from said common interconnecting line at a portion of said common interconnecting line and leading said common interconnecting line through a connection terminal to an external circuit,
wherein said common interconnecting line, disposed along a side of the display area most distant from a lead-out portion at which said lead-out interconnecting line branches off from said interconnecting line, has a width narrower than a width of said common interconnecting line disposed along other sides of the display area.

2. An apparatus according to claim 1, wherein the contact hole, through which the common interconnecting line disposed along the side of the display area most distant from the lead-out portion is electrically connected to the second electrode, has a width narrower than a width of the contact hole through which the common interconnecting line disposed along other sides of the display area is electrically connected to the second electrode.

3. An apparatus according to claim 1, wherein between the common interconnecting line disposed along the side of the display area most distant from the lead-out portion and an edge of the substrate close to the side, a drive circuit for driving the device control circuit is disposed.

4. An apparatus according to claim 1, wherein the side of the display area most distant from the lead-out portion is parallel to scanning lines, and between the side and an edge of the substrate close to the side, a signal line drive circuit is disposed.

5. An apparatus according to claim 3, wherein the side of the display area most distant from the lead-out portion is parallel to signal lines, and between the side and an edge of the substrate close to the side, a scanning line drive circuit is disposed.

6. An apparatus according to claim 1, wherein the side of the display area most distant from the lead-out portion is parallel to a power source line in the display area.

7. An apparatus according to claim 1, wherein the side of the display area most distant from the lead-out portion is perpendicular to a power source line in the display area.

8. An apparatus according to claim 1, wherein the lead-out portion is provided in a plurality of lead-out portions disposed at positions close to a side of the display area.

9. An apparatus according to claim 1, wherein the lead-out portion is disposed at two positions close to first and second sides of the display area, and the common interconnecting line disposed along other than sides of the display area distant from the lead-out portion has a width narrower than a width of the common interconnecting line disposed along the first and second sides of the display area.

10. A camera comprising:
a display apparatus according to claim 1;
a shooting portion for shooting subject of shooting; and
an image signal processing portion for processing a signal of image shot by said shooting portion,
wherein said image signal processing portion processes an image signal so as to display an image by said display apparatus.
